(19) United States
(12) Patent Application Publication
(10) Pub. No.: US 2008/0252920 A1
(43) Pub. Date: Oct. 16, 2008

(54) PRINTING SYSTEM AND CONTROL METHOD THEREOF

(75) Inventors: Shinji Koizumi, Mishima-shi (JP); Takanori Fukuhara, Mishima-shi (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 11/733,956

(22) Filed: Apr. 11, 2007

(51) Int. Cl. G06F 3/12

(52) U.S. Cl. 358/1.15; 726/19

(57) ABSTRACT

A printing system according to the invention is a printing system including a printer and a host computer that is connected to the printer via a network and has a display unit, wherein the printer includes a printer main body that has a control unit, an output unit that outputs a print printed by the printer main body, a box with a lock mechanism that temporarily stores the print output from the output unit, and a sensor that detects presence or absence of the print in the box, and the host computer displays on the display unit an indication on whether there is an empty box on the basis of information on the presence or absence of the print in the box detected by the sensor and transmitted from the printer.

### BACKGROUND OF THE INVENTION

1. Field of the Invention

The present invention relates to a printing system and a control method thereof, and, more particularly to a printing system in which print control is applied from a host computer to printers connected to a network and a control method of the printing system.

2. Description of the Related Art

In these days, a printing system is widely spread in which document data and image data are transmitted from a host computer such as a personal computer to printers (including a copying machine having a printer function and an MFP (Multi-Function Peripheral)) connected to a network such as a LAN and documents and images are printed.

In this printing system, a user issues a print instruction from a location distant from a printer and, then, goes to an installation location of the printer to receive prints at a proper time when the printing is considered to be finished. When it takes time to go and receive the prints or when the user forgets that the user has printed the prints, the prints left on an output tray of the printer are exposed to a third party's eyes for a relatively long time. It is also likely that the prints are illegally taken out by the third party. Therefore, when the prints are related to confidential information, it is likely that a secret leaks.

To ensure security of information, there is a printing method called private printing. In this printing method, even if a user issues a print instruction from a host computer of the user, document data and image data are temporarily saved in a memory of a printer rather than being actually printed. The saved data is printed and prints are output to an output tray of the printer only when the user goes to an installation location of the printer and operates a control panel or the like. In this private printing, it is unlikely that the prints are exposed to a third party's eyes or the prints are illegally taken out by the third party.

However, when the private printing is used, the user needs to wait in front of the printer until all prints are output after the user performs print operation from the control panel or the like. Thus, when a print quantity is large, the user has to wait in front of the printer for a long time and wastes time.

In order to cope with such an inconvenience, for example, JP-A 2004-227216 discloses a technique for providing an output box with a lock mechanism in a printer. Highly confidential prints are output to the output box with the lock mechanism rather than a shared output tray and only an authorized person unlocks the lock mechanism with a key owned by the authorized person and takes out the prints in the output box with the lock mechanism. According to the technique disclosed by JP-A 2004-227216, prints including confidential information are not exposed to a third party's eyes and it is possible to prevent the prints from being illegally taken out. Further, it is unnecessary to wait for a long time in front of the printer until printing is finished as in the private printing.

A printer installed in an office or the like is usually shared by a large number of users. Therefore, a situation could often occur in which, since a certain user already uses an output box, i.e., prints are already put in the output box, the other users cannot use this output box. The technique disclosed in JP-A 2004-227216 cannot cope with such a situation. Although the printer includes the output box with the lock mechanism itself, convenience concerning use of the output box is insufficient on the assumption that a large number of users use the output box.

### SUMMARY OF THE INVENTION

The present invention has been devised in view of the circumstances and it is an object of the invention to provide a printing system including an output box with a lock mechanism, the printing system making it possible to use the output box with high convenience even if a large number of users use the output box, and a control method of the printing system.

In order to attain the object, a printing system according to an aspect of the invention is a printing system including a printer and a host computer that is connected to the printer via a network and has a display unit, wherein the printer includes a printer main body that has a control unit, an output unit that outputs a print printed by the printer main body, a box with a lock mechanisms that temporarily stores the print output from the output unit, and a sensor that detects presence or absence of the print in the box, and the host computer displays on the display unit an indication on whether there is an empty box on the basis of information on the presence or absence of the print in the box detected by the sensor and transmitted from the printer.

In order to attain the object, a control method of a printing system according to another aspect of the invention is a control method of a printing system including a printer and a host computer that is connected to the printer via a network and has a display unit, the control method including the steps of (a) printing a print on the basis of an instruction from the host computer, (b) outputting the print to a box with a lock mechanism, (c) temporarily storing the print output in the box with the lock mechanism, (d) detecting presence or absence of the print in the box, and (e) displaying on the display unit an indication on whether there is an empty box on the basis of information on the presence or absence of the print in the box detected.

### BRIEF DESCRIPTION OF THE DRAWINGS

In the accompanying drawings:

FIG. 1A is a front view showing an example of an external appearance of a printer included in a printing system according to an embodiment of the invention;

FIG. 1B is a diagram showing an example of an external appearance of a security box included in the printer;

FIG. 2 is a block diagram showing an example of a structure of the printing system according to the embodiment of the invention;

FIG. 3 is a flowchart showing an example of processing from a print instruction by a host computer until prints are output to the security box;

FIG. 4 is a flowchart showing an example of processing for managing a storage time-limit of prints; and

FIG. 5 is a flowchart showing an example of processing for taking out prints.

### DETAILED DESCRIPTION OF THE PREFERRED EMBODIMENTS

Embodiments of a printing system and a control method thereof according to the invention will be explained with reference to the accompanying drawings.

(1) Structure of a printing system

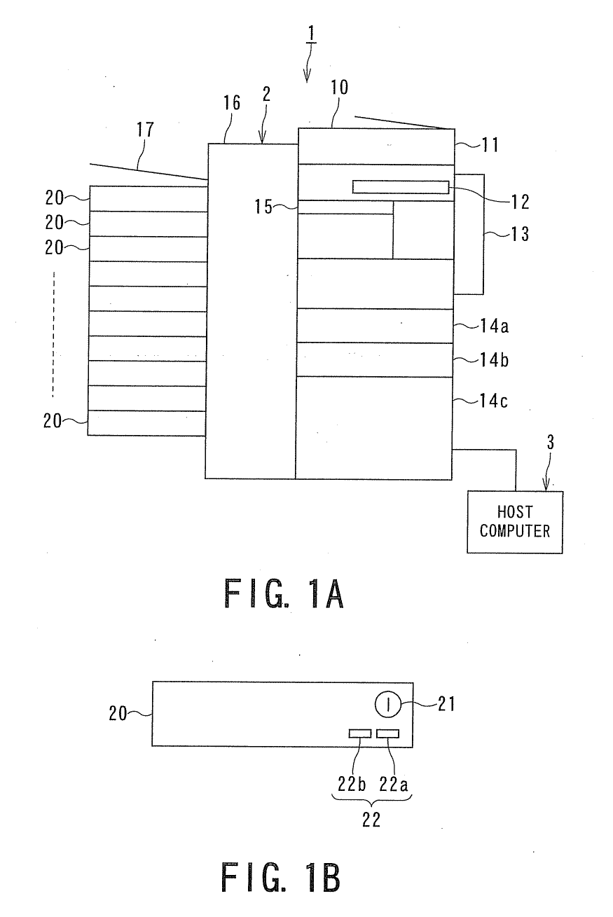

FIG. 1A is a front view schematically showing a structure of a printer 2 included in a printing system 1 according to an embodiment of the invention. FIG. 1B is a front view schematically showing plural security boxes (boxes) 20 included in the printer 2.

A host computer 3 is connected to the printer 2 via a network. The printing system 1 is constituted by including the printer 2 and the host computer 3.

The host computer 3 transmits document data and image data to the printer 2 and instructs the printer 2 to print the document data and the image data.

The printer 2 may be an apparatus exclusive for printing or may be a copying machine or an MFP having a printer function (a function of printing the document data and the image data on a sheet on the basis of the print data and the print instruction transmitted from the host computer). In the following explanation, explanations will be made with an MFP having a copying function and a scanner function in addition to the printer function as an example of the printer 2.

The printer 2 according to this embodiment includes a printer main body 10, an output unit 16 (also referred to as a finisher), a shared tray 17, and the plural security boxes (boxes) 20.

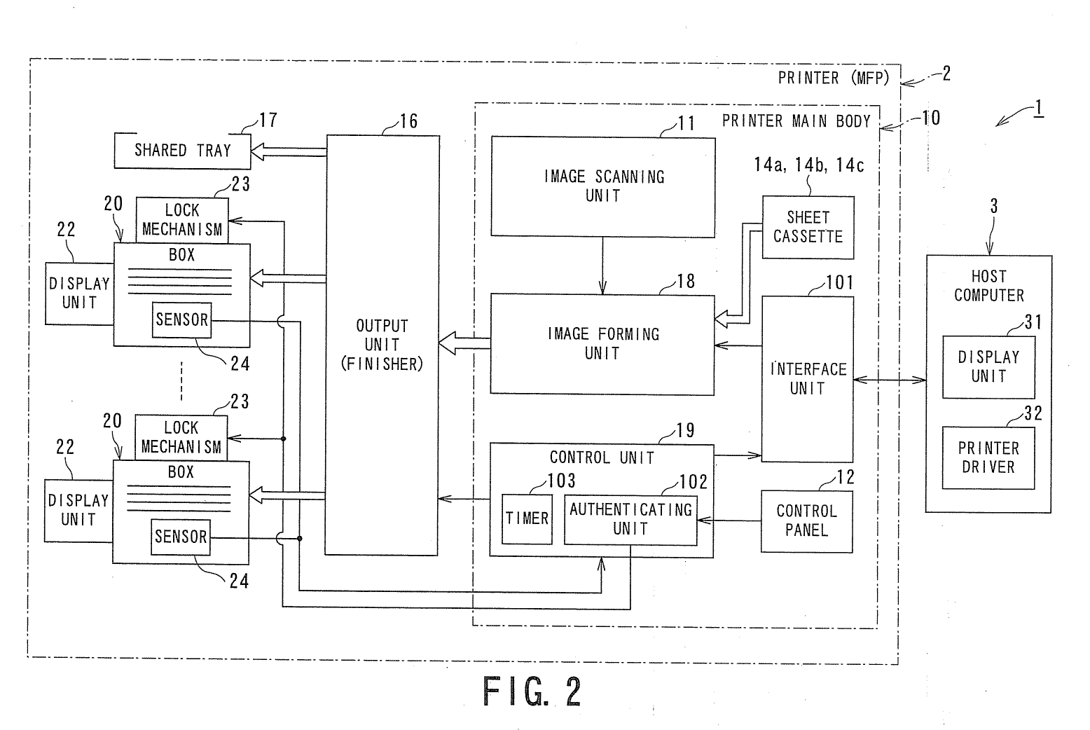

The printer main body 10 includes an image scanning unit 11 that scans an original, a control panel 12 that applies various kinds of operation to the printer 2, sheet cassettes 14a, 14b, and 14c that store sheets of various sizes, an automatic duplex unit 13 for performing duplex printing, a conveyance relaying unit 15 that relays the sheets supplied from the sheet cassettes 14a, 14b, and 14c to an image forming unit 18 (see FIG. 2), and the like.

Document data or image data output from the host computer 3 is printed on sheets by the printer main body 10. The sheets having the document data or the image data printed thereon (prints) have output destinations allocated thereto by the output unit 2 and are output to the shared tray 17 or the security boxes 20.

The shared tray 17 is a tray to which anybody can make access. The prints are output to the shared tray 17 when the security boxes 20 are not designated as the output destination or when the prints are not entirely stored in the security boxes 20.

On the other hand, the security boxes 20 are boxes of a closed type that have doors with lock mechanisms. The security boxes 20 are constituted to make it impossible to see or take out the prints output therein unless the lock mechanisms are unlocked using a key.

FIG. 1B is a front view schematically showing one of the security boxes 20 (a view of one of the security boxes 20 in FIG. 1A viewed from the left).

A key hole 21 is provided in the security box 20. A lock mechanism 23 (see FIG. 2) is unlocked by inserting a physical key in the key hole 21.

The lock mechanism 23 may be unlocked by authentication using an electronic key rather than unlocking the lock mechanism 23 with the physical key. As the authentication using the electronic key, it is possible to use, for example, password authentication, token authentication using a radio ID tag, a magnetic card, and IC card, and the like, biometrics authentication using a fingerprint and the like. The authentication by these electronic keys and the physical key may be used together.

Display units 22a and 22b using, for example, LEDs are provided on a front surface of the security box 20. The display units 22a and 22b are displays for letting a user to know a state of prints in the security box 20. For example, the display unit 22a of a green color is lit when the prints are output in the security box 20 and the display unit 22b of a red color is lit when a storage period of the prints has exceeded a predetermined period.

FIG. 2 is a block diagram showing a structure of the printing system 1 mainly from a functional viewpoint.

The printing system 1 includes the printer 2 and the host computer 3. A printer driver 32 that controls the printer 2 is installed in the host computer 3. A screen for print control is displayed on a display unit 31 by the printer driver 32. The user sets various printing parameters such as the number of copies to be printed and a sheet size on this screen and, then, clicks a print button in the screen to perform a print instruction.

Selection of an output destination of prints (the shared tray 17 or the security boxes 20) is also performed using the screen for print control.

The printer 2 has, as described above, the printer main body 10, the output unit 16, the shared tray 17, and the plural security boxes 20. The printer main body 10 has the image scanning unit 11, the image forming unit 18, a control unit 19, the control panel 12, the sheet cassettes 14a, 14b, and 14c, an interface unit 101, and the like.

Document data and the like transmitted from the host computer 3 are input to the image forming unit 18 via the interface unit 101. The image forming unit 18 prints the document data and the like on sheets supplied from the sheet cassettes 14a, 14b, and 14c according to, for example, an electrophotographic system.

On the other hand, the control unit 19 determines, on the basis of output destination information transmitted from the host computer 3 together with the document data and the like, whether prints are output to the shared tray 17 or output to the security boxes 20. When there are the plural security boxes 20 as shown in FIG. 1A and FIG. 2 as an example, the control unit 19 specifies the security box 20 to which the prints should be output.

The output unit 16 outputs prints having the document data and the like printed thereon by the image forming unit 18 to the output destination (the shared tray 17 or the specific security box 20) determined by the control unit 19.

A sensor 24 is provided in each of the security boxes 20 and detects, for each of the security boxes 20, that prints are stored in the security box. Other than detecting presence or absence of the prints in the box using the sensor 24, a quantity of prints may be detected.

Detection information of the sensor 24 is conveyed to the control unit 19. The control unit 19 lights the display unit 22a in, for example, a green color. This display makes it possible to visually recognize easily even from the outside that the prints are stored in the security box 20.

According to the detection of the prints by the sensor 24, the control unit 19 is capable of identifying the security box 20 in which the prints are already stored and the empty security box 20. When the control unit 19 is instructed from the host computer 3 anew to output prints to the security box 20, the control unit 19 searches for the empty security box 20 on the basis of information of the sensor 24 and controls the output unit 16 to output the prints to the empty security box 20.

The control unit 19 has a timer 103 that measures a storage period of prints for each of the security boxes 20. When it is detected by the sensor 24 that prints have been output to the security box 20, the control unit 19 starts this timer 103. When the storage period exceeds a predetermined period, notification to that effect is transmitted from the control unit 19 to the host computer 3. According to this function, it is possible to urge a user who carelessly forgets that the user has printed the prints to collect the prints. It is possible to prevent one user from uselessly occupying the security box 20 for a long period. This makes it possible to more effectively utilize the security box 20.

The control unit 19 has an authenticating unit 102. When the lock mechanism of the security box 20 is unlocked by the electronic key, authentication of the electronic key is performed by this authenticating unit 102.

When the prints are taken out from the security box 20, a user who holds the physical key or the electronic key directly opens the security box 20. This makes it possible to prevent highly confidential prints from being exposed to a third party's eyes.

When the security box 20 is opened using the electronic key, authentication of the electronic key is necessary. This authentication is performed by the authenticating unit 102 of the control unit 19. When the authentication of the electronic key is password authentication, a user inputs a password of the user from, for example, the control panel 12. The authenticating unit 102 performs matching of the password input and a password registered in advance and authenticates the electronic key.

In the case of the token authentication using a radio ID tag, a magnetic card, an IC card, and the like and the biometrics authentication using a fingerprint and the like, the authenticating unit 102 reads authentication information of the various tokens, the fingerprint, and the like using a reading device provided in, for example, the control panel 12, performs matching of the authentication information read and authentication information registered in advance, and authenticates the electronic key.

When the authentication of the electronic key is successful, an unlock signal is output to the lock mechanism of the security box 20 corresponding to the electronic key from the control unit 102 and the user is capable of taking out the prints.

When the prints are taken out, it is detected by the sensor 24 that the inside of the security box 20 is empty. The control unit 19 manages the security box 20 as the empty security box 20.

(2) Control Method of the Printing System

A control method of the printing system 1 constituted as described above will be explained more in detail.

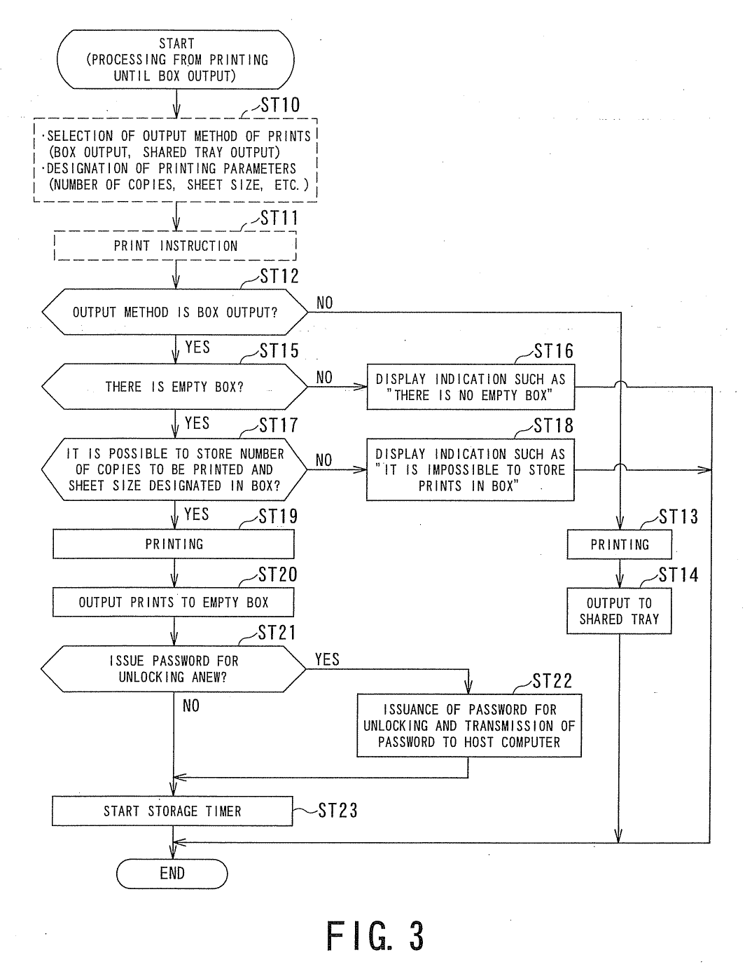

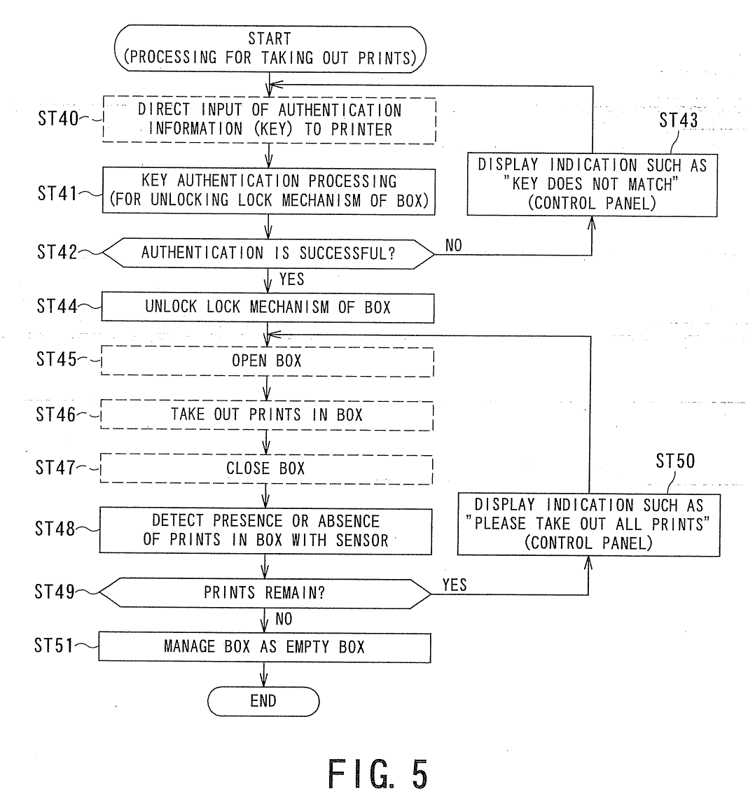

FIG. 3 is a flowchart showing an example of processing from printing according to an instruction from a host computer 3 until prints are output to the security box 20. These kinds of processing are mainly performed by the control unit 19 of the printer main body. Operation performed by a user is distinguished and indicated by boxes of broken lines (the same applies in FIG. 5).

First, after designating document data or image data that the user attempts to print, the user performs, from the host computer 3, selection of an output method of the prints (whether the prints are output to the shared tray 17 or output to the security box 20) and setting of printing parameters such as the number of copies to be printed and a sheet size (step ST10). Thereafter, the user issues a print instruction to the printer 2 from the host computer 3 (step ST11).

The control unit 19 of the printer 2 determines on the basis of information sent from the host computer 3 whether an output destination of the prints is the security box 20 (step ST12). When the output destination is not the security box 20 (i.e., when the output destination is the shared tray 17), after printing the prints in step ST13, the control unit 19 outputs the prints to the shared tray 17 (step ST14).

On the other hand, when the output destination of the print is the security box 20, the control unit 19 determines on the basis of detection information of the sensor 24 whether there is an empty box (step ST15). When there is no room in all the security boxes 20, the control unit 19 notifies the host computer 3 to that effect. The host computer 3 displays on the display unit 31 an indication such as “There is no empty box” (step ST16) and finishes the processing.

When there is the empty security box 20, the control unit 19 determines whether it is possible to store the prints of the number of copies to be printed and the sheet size designated in the security box 20 (step ST17). When it is impossible to store the prints of the quantity and the size designated, the control unit 19 notifies the host computer 3 to that effect. The host computer 3 displays on the display unit 31 an indication such as “It is impossible to store the prints in the box” (step ST18) and finishes the processing.

When it is possible to store the prints of the quantity and the size designated in the security box 20, after printing the prints (step ST19), the control unit 19 outputs the prints to the empty security box 20.

When the number of copies of the prints is large in step ST17, the control unit 19 may determine whether it is possible to distribute and output the prints to the plural security boxes 20. In this case, the control unit 19 performs the determination from the number of empty security boxes 20 and the number of copies to be printed. When it is impossible to store all the prints in the security boxes 20 even if the prints are distributed or when there is no security box 20 capable of storing the prints of the sheet size designated, the control unit 19 proceeds to step ST18.

On the other hand, when it is possible to store the prints if the prints are distributed, in step ST20, the prints are distributed and output to the plural security boxes 20.

Besides, processing for notifying, when it is impossible to store the prints in the security box 20, the host computer 3 whether the prints should be output to the shared tray 17 and, if an approval of the user is obtained, outputting the prints to the shared tray 17 may be provided.

When the prints are output to the security box 20, the print instruction performed in step ST11 may be performed after an affirmative determination in step ST17. In this case, a print instruction is given to the printer 2 after it is confirmed in advance that it is possible to store the prints in the security box 20.

Subsequently, the control unit 19 determines whether a password for unlocking the lock mechanism of the security box 20 should be issued anew (step ST21). When a password is used as the electronic key, by generating a new password on the basis of, for example, a random number, every time printing is performed, it is possible to prevent damage due to leakage of the password. The password issued anew is transmitted to the host computer 3 (step ST22). The user unlocks the lock mechanism of the security box 20 using this password.

On the other hand, when a password is not used as the electronic key or when the user does not desire issuance of a new password and sets the control unit 19 not to perform new issuance of a password, it is determined in step ST21 that issuance of a password is unnecessary. In this case, the control unit 19 proceeds to step ST23. In step ST23, the control unit 19 starts the storage timer 103 of the security box 20 corresponding to the electronic key.

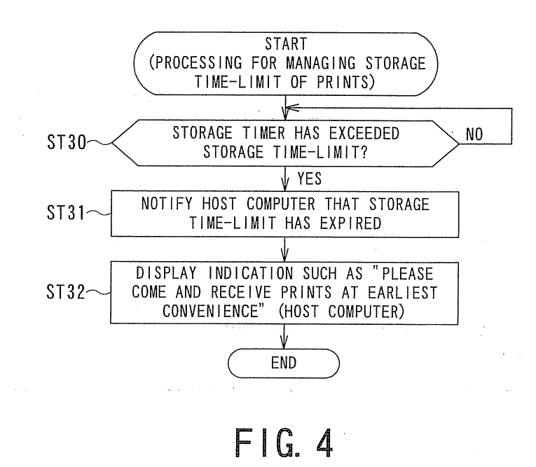

FIG. 4 is a flowchart showing an example of processing for managing a storage time-limit of prints. The control unit 19 determines whether a storage time-limit set in advance on the storage timer 103 has expired (step ST30). When the storage time-limit has expired, the control unit 19 notifies the host computer 3 to that effect (step ST31).

The host computer 3 having received the notification displays on the display unit 31 an indication such as “Please come to receive prints at your earliest convenience” and urges the user to collect the prints early (step ST32).

FIG. 5 is a flowchart showing an example of processing for taking out prints performed by the control unit 19.

When prints output to the security box 20 are taken out, the user directly goes to the installation location of the printer 2 and directly inputs authentication information (a password, etc.) of the electronic key from the control panel 12 or the like (step ST40).

The control unit 19 of the printer 2 performs key authentication processing according to matching of the authentication information input and authentication information registered (step ST41). The authentication is successful when both the kinds of authentication information match (YES in step ST42). The control unit 19 unlocks the lock mechanism of the security box 20 corresponding to the electronic key (step ST44).

On the other hand, in the case of failure in the authentication, the control unit 19 causes the control panel 12 to display a warning indication such as “The key does not match”, urges the user to input authentication information of the electronic key again, and returns to step ST40. When the user fails in authentication the number of times equal to or larger than a predetermined number of times, the control unit 19 may finish the processing at that point.

When the lock mechanism is unlocked, the user opens the door of the security box 20, takes out the prints in the security box 20, and closes the door (steps ST45, ST46, and ST47).

The sensor 24 of the security box 20 detects presence or absence of the prints in the security box 20 (step ST48). According to a result of this detection, the control unit 19 determines whether the prints remain (step ST49). When the prints remain in the security box 20, the control unit 19 causes the control panel 12 to display a warning indication such as “Please take out all the prints” (step ST50) and prevents the user from forgetting to take out a part of the prints.

When it is determined that there is no print remaining in the security box 20, the control unit 19 manages this security box as an empty box (step ST51).

As explained above, according to the printing system 1 and the control method thereof according to this embodiment, in the printing system 1 that has the printer 2 including the security boxes 20 with lock mechanisms, an empty state of the security boxes 20 is detected by the sensors 24 and, when there is no room in the security boxes 20, an indication to that effect is notified to the host computer 3. As a result, a large number of users present in locations remote from the printer 2 can learn in advance whether it is possible to use a limited number of security boxes 20. Thus, there is no competition in using the security boxes 20 and convenience of the security boxes 20 is not spoiled.

A storage time-limit of prints output to the security boxes 20 is managed by the storage timer 103. When the storage period exceeds a predetermined storage period, this is notified to users of the host computer 3. Thus, wasteful usage of the security boxes 20 is reduced and it is possible to realize effective utilization of the security boxes 20 for a larger number of users.

The present invention is not limited to the embodiments per se. At an implementation stage, it is possible to modify and embody the elements without departing from the spirit of the invention. It is also possible to form various embodiments of the invention according to appropriate combinations of the plural elements disclosed in the embodiments. For example, several elements may be deleted from all the elements described in the embodiments. Moreover, elements described in different embodiments may be appropriately combined.

What is claimed is:

1. A printing system comprising:
a printer; and
a host computer that is connected to the printer via a network and has a display unit, wherein
the printer includes:
a printer main body that has a control unit;
an output unit that outputs a print printed by the printer main body;
a box with a lock mechanism that temporarily stores the print output from the output unit; and
a sensor that detects presence or absence of the print in the box, and
the host computer displays on the display unit an indication on whether there is an empty box on the basis of information on the presence or absence of the print in the box detected by the sensor and the transmitted from the printer.

2. A printing system according to claim 1, wherein
the printer includes a plurality of the boxes, and
the control unit searches for an empty box on the basis of information on presence or absence of the print in each of the boxes detected by the sensor and controls the output unit to output the print to the empty box.

3. A printing system according to claim 1, wherein
the printer includes a plurality of the boxes, and
the control unit controls, when it is impossible to store a quantity of prints for which a print instruction is received from the host computer in one box, the output unit to store the prints dividedly in two or more boxes.

4. A printing system according to claim 1, wherein
the printer further includes a shared tray to which prints of unspecified users are output, and
the control unit searches for an empty box on the basis of the information on presence or absence of the print in each of the boxes detected by the sensor and, when there is no empty box, controls the output unit to output a print to be printed anew to the shared tray.

5. A printing system according to claim 1, wherein
the printer further includes a timer that measures a storage period of the print stored in the box, and
the control unit notifies, when the storage period measured by the timer exceeds a predetermined period, the host computer, which has instructed printing of the stored print, that the storage period has exceeded the predetermined period.

6. A printing system according to claim 1, wherein
the printer further includes a timer that measures a storage period of the print stored in the box, and
the box includes a display unit that displays, when the storage period measured by the timer exceeds a predetermined period, an indication to that effect.

7. A printing system according to claim 1, wherein
the control unit includes an authenticating unit that authenticates a user who uses the box, and
the authenticating unit performs user authentication on the basis of authentication information input by the user and, when the user authentication is successful, unlocks the lock mechanism of the box.

8. A printing system according to claim 7, wherein
the authentication information is a password, and
the control unit generates a random password after the print is output to the box and transmits the password generated to the host computer, which has instructed printing of the print.

9. A control method of a printing system including a printer and a host computer that is connected to the printer via a network and has a display unit, the control method comprising the steps of:
(a) printing a print on the basis of an instruction from the host computer;
(b) outputting the print to a box with a lock mechanism;
(c) temporarily storing the print output in the box with the lock mechanism;
(d) detecting presence or absence of the print in the box; and
(e) displaying on the display unit an indication on whether there is an empty box on the basis of information on the presence or absence of the print in the box detected.

10. A control method of a printing system according to claim 9, wherein
the printer includes a plurality of the boxes, and
in step (b), an empty box is searched for on the basis of information on presence or absence of the print in each of the boxes and the print is output to the empty box.

11. A control method of a printing system according to claim 9, wherein
the printer includes a plurality of the boxes, and
in step (b), when it is impossible to store a quantity of prints for which a print instruction is received from the host computer in one box, the prints are dividedly output to two or more boxes.

12. A control method of a printing system according to claim 9, wherein
the printer further includes a shared tray to which prints of unspecified users are output, and
in step (b), an empty box is searched for on the basis of the information on presence or absence of the print in each of the boxes detected and, when there is no empty box, the print is output to the shared tray.

13. A control method of a printing system according to claim 9, wherein
the printer further includes a timer that measures a storage period of the print stored in the box, and
the control method further includes the step of notifying, when the storage period measured by the timer exceeds a predetermined period, the host computer, which has instructed printing of the stored print, that the storage period has exceeded the predetermined period.

14. A control method of a printing system according to claim 9, wherein
the printer further includes a timer that measures a storage period of the print stored in the box, and
the control method further includes the step of displaying, when the storage period measured by the timer exceeds a predetermined period, an indication to that effect.

15. A control method of a printing system according to claim 9, further comprising the step of performing user authentication on the basis of authentication information input by a user who uses the box and, when the user authentication is successful, unlocking the lock mechanism of the box.

16. A control method of a printing system according to claim 15, wherein
the authentication information is a password, and
the control method further includes the step of generating a random password after the print is output to the box and transmitting the password generated to the host computer, which has instructed printing of the print.
